(19) United States
(12) Patent Application Publication
(10) Pub. No.: US 2004/0122684 A1
(43) Pub. Date: Jun. 24, 2004

(54) Method and apparatus for a call cost indicator

(75) Inventor: Terho Kaikuranta, Piispanristi (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corp.

(21) Appl. No.: 10/324,700

(22) Filed: Dec. 18, 2002

(51) Int. Cl. G06F 17/60

(52) U.S. Cl. 705/1; 705/400

(57) ABSTRACT

A method by which a user of a portable communications device subscribed to a telecommunication network is provided with an indication of the cost of engaging a communication service available through the telecommunication network. The cost indication can be either quantitative or qualitative, and can be updated during the use of the service as the cost changes. Portable communication devices operative so as to provide such a cost indication are provided, as well as network elements providing to portable communication devices such a cost indication.

### BACKGROUND OF THE INVENTION

1. Technical Field

The present invention relates to a portable communication device capable of communicating with another device using a communication resource at a cost and, more particularly, to a user interface therefor.

2. Discussion of Related Art

It is difficult for a user of a portable communication device such as a cell phone to monitor call cost level at given network, time and condition. There is presently no way to ascertain call cost before making a call. This is particularly problematic for data calls. To avoid high costs, end users should try to remember low price periods during a day or week. But end users do not usually remember which cellular systems/protocols (=price level) are available at any specific time and location. The user could use a call cost counter during a call or use operator pricing time tables, but such are awkward to use and users are prone to misplace them or not know how to use them.

Many find it useful to delay making calls into evening time for a cheaper price. Today, there is no method for monitoring the moment of change in pricing. Pricing times must be remembered.

When multiple cellular protocols are available, phone users normally want to use the lowest cost option. However, the pricing policy of telephone operators and mobile usage of a terminal makes it difficult to estimate price for a new call to be made.

As mobile phones manufacturers integrate more and more data protocols—such as TDMA, CDMA, WCDMA, 900/1800 MHz, 1900 MHz, GPRS (General Packet Radio Service), Bluetooth, WLAN, and so on—the problem will increase, especially for the price sensitive markets. Telecommunication operators have been using pricing as a marketing tool to guide clients to use network capacity that would be advantageous for them or to offer different service performance according to customer need.

### DISCLOSURE OF INVENTION

An object of the present invention is to provide a user interface for cost indication.

Another object of the invention is to provide an intuitive cost level indicator, that can be used to assist end users to make it easier to understand current cost level.

According to a first aspect of the present invention, a method is provided, for use in a portable communication device capable of communicating with another device using a communication resource at a cost, comprising the steps of: receiving a cost information signal indicative of said cost; and communicating a cost indicator for perception by a user of said portable communication device, the cost indicator based on the cost information signal and indicative of said cost.

In accord with the first aspect of the invention, said step of communicating may comprise the step of displaying said cost indicator on a display of said portable communication device for said perception by said user of said portable communication device. Further, said displaying said cost indicator may be carried out by displaying different colors of displayed pixels or pixel structures signifying different cost levels with one color displayed at a time to signify a corresponding cost level. Also further, said displaying said cost indicator may be carried out by displaying a graphical icon that changes size in steps with a larger size signifying a higher cost. Still also further, said displaying said cost indicator may be carried out by displaying a graphical icon that shows said cost with respect to a selected currency, and said icon may show said cost with respect to one or more price level marks indicative of one or more corresponding price levels in said selected currency. Also further, said step of displaying said cost indicator may be carried out by displaying a graphical icon indicative of a price level per unit time. Even still also further, said cost indicator may alternate on said display with a field strength indicator.

Also in accord with the first aspect of the invention, in place of communicating a cost indicator for perception by a user of said portable communication device, the method may include the steps of: transferring the cost information signal from said portable communication device to another portable communication device via connectivity provided by other than the telecommunication network; and communicating a cost indicator for perception by a user of said other portable communication device, the cost indicator based on the cost information signal and indicative of said cost.

In a second aspect of the invention, a method is provided, for use by a network element of a telecommunication network enabling a portable communication device to engage a communication service at a cost so as to communicate with another device, the method comprising the steps of: receiving a signal from the portable communication device indicating to the network element the identity of the portable communication device; and transmitting to the portable communication device a signal conveying cost information indicative of the cost for engaging a communication service.

In accord with the second aspect of the invention, the signal from the portable communication device may indicate the communication service and the cost information may be limited to the indicated communication service.

Also in accord with the second aspect of the invention, the cost information may not be limited to a particular communication service.

Also in accord with the second aspect of the invention, the cost information may be information indicative of a total charging rate for the communication service.

Also in accord with the second aspect of the invention, the cost information may be a current total cost accrued during a communication session using the communication service.

Also in accord with the second aspect of the invention, the cost information may indicate different billing rates for use of the communication service during different time periods.

Also in accord with the second aspect of the invention, before the step of transmitting the cost information, the network element may perform the step of aggregating component cost information indicative of component costs for engaging the communication service. Further, in aggregating component cost information, the network element may arithmetically add together the component costs. Also further, in aggregating component cost information, the network element may assemble different component cost information into a single cost information document or table. Still also further, the communication service may be provided over a communication path including path segments provided by different operator networks, and in aggregating component cost information, the network element may receive component cost information from a network element in at least one operator network different from the operator network to which the aggregating network element belongs. Also further, each component cost may be a cost for a respective one of a plurality of media. Also further, each component cost may be a cost for a respective one of a plurality of path segments over which the communication service is conveyed.

Also in accord with the second aspect of the invention, the cost information may be transmitted before receiving the signal indicating the communication service.

Also in accord with the second aspect of the invention, the cost information may be transmitted after receiving the signal indicating the communication service. Further, the signal indicating the communication service may be a signal making use of the indicated communication service. Also further, the signal indicating the communication service may be a signal indicating a communication service a user of the portable communication device is not using but for which the user requests cost information. In such a case, the network element may obtain the cost information independent of whether an invoice is generated for the user in connection with use of the communication service. Also in such a case, the user may make use of the communication service after receiving the cost information. Still also in such a case, the network element may obtain the cost information from at least one billing system. Even still also in such a case, the network element may obtain the cost information from a plurality of billing systems, each an element of an operator network that participates in providing the communication service. Still even also in such a case, the network element may obtain the cost information from a Network Control Center (NCC) via Application Programming Interface (API) calls to the NCC, and the network element may be a Multimedia Service Center (MMSC) or a Short Message Center Service center (SMSC), among other kinds of network elements. Yet even still also, a credit check may be performed in combination with providing the cost information, and the user may be allowed to order the communication service only if the credit check indicates a favorable user credit report.

In a third aspect of the invention, a portable communication device capable of communicating with another device using a communication resource at a cost is provided, the portable communicating device comprising means so as to be operative according to the first aspect of the invention.

In a fourth aspect of the invention, a network element is provided, comprising means so as to be operative according to the second aspect of the invention.

In a fifth aspect of the invention, a system is provided, comprising a portable communication device according to the third aspect of the invention and a network element according to the fifth aspect of the invention.

The present invention thus provides a user interface feature for current phone call price level indication by means of an intuitive price level indicator that can be used to assist end users to make it easier to understand the current call cost level. End user awareness of the call cost level before a call is initiated is also improved. Improved product usability and “product happiness” is realized because the user gets more of a feeling of control of the cost. The invention therefore promotes low cost use of mobile phones which is important in cost sensitive markets. Increased terminal market penetration can be expected as a result because of more price-sensitive end user behavior. It enables a new operator marketing channel (real time special offers, happy-hour pricing, etc.). End users do not have to think of selecting network systems, they can focus on their real interest—the cost—and let the technology take care of the selection of a suitable network connection.

These and other objects, features and advantages of the present invention will become more apparent in light of the following detailed description of a best mode embodiment thereof, as illustrated in the accompanying drawing.

### BRIEF DESCRIPTION OF THE DRAWINGS

FIG. 1 shows a call cost indicator, according to the present invention.

FIG. 2 shows a user ordering a smart messaging call cost indication service from a network as well as an illustration of the service in use after installation.

FIG. 3(a) shows an RF field indicator with a red color coded cost information to show a high cost.

FIG. 3(b) shows a yellow RF field indicator to indicate medium cost.

FIG. 3(c) shows an RF field indicator with a green color coded cost indicator to indicate low cost.

FIG. 4 shows a user making a cost inquiry, the network evaluating cost, informing the terminal, the cost being accepted by the user and the service ordered.

FIG. 5 shows a portable communication device capable of communicating with another device using a communication resource at a cost.

FIG. 6 shows a concrete example of the portable communication device of FIG. 5 in the form of a mobile phone communicating over a radio link with a radio access network.

FIG. 7 shows another device with which the portable communication device of FIG. 8 or the mobile phone of FIG. 6 may be in communication via various networks, all having their own cost associated therewith for use of their communication resources.

FIG. 8 shows a prior art mobile phone display having a standard field strength indicator in a left most vertical edge area of the display in the form of a field strength bar having a plurality of line segments stacked one on top of the other with an increasing number of line segments indicting higher field strength.

FIG. 9 shows a method for use in a portable communication device that receives a cost information signal indicative of the cost of using a communication resource and displaying a cost indicator based on the cost information signal and indicative of the cost, for perception by a user of the portable communication device.

FIG. 10 shows a portable communication device communicating with another device using a communication resource at a cost, according to the present invention.

FIG. 11 shows a method for use by a network element in providing cost information to a portable communication device, according to the invention.

FIG. 12 indicates the aggregating of component cost information by a network element operative according to the invention.

FIG. 13 shows an illustrative example of a network element making application programming interface (API) calls to obtain cost information. What is shown is simplified for clarity; actual systems typically have more complicated software architecture. For a more realistic description, see the Symbian World Wide Web pages at http://www.symbian.com/, which offer a more detailed presentation of a well-known public software architecture and its functionality, including the use of APIs. See in particular the detailed descriptions in the SKD/developer section.

### BEST MODE FOR CARRYING OUT THE INVENTION

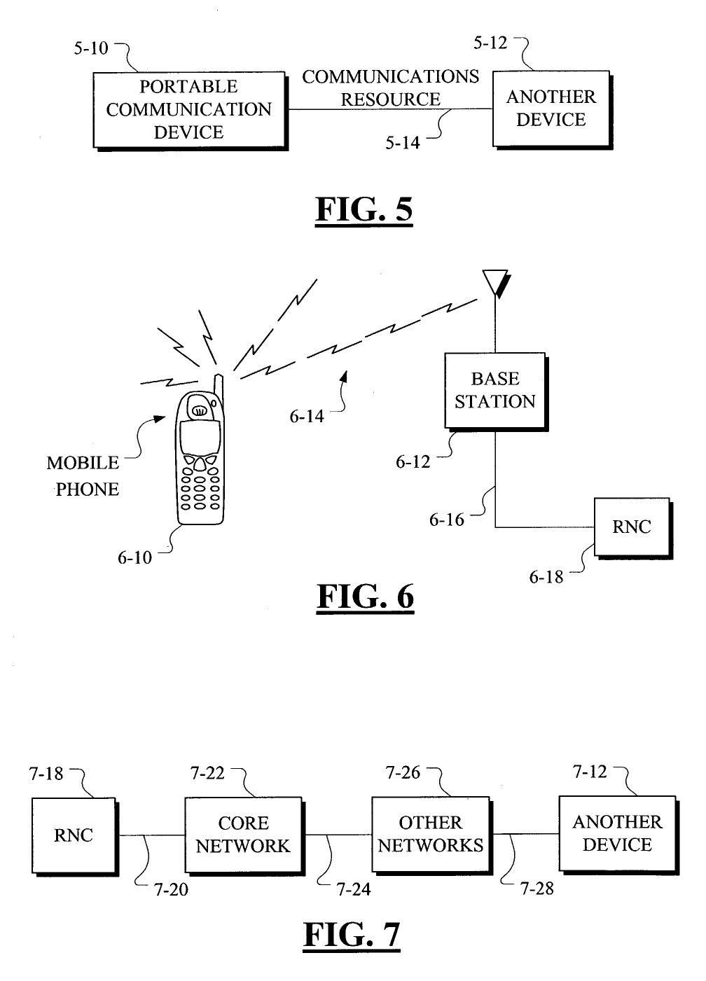

FIG. 5 shows a portable communication device 5-10 connected to another device 5-12 by means of a communication resource 5-14 at a cost. In other words, the communication resource 5-14 is scarce and it costs the user of the portable communication device 5-10 a certain amount of money to use it. The amount depends on time of use, quantity of data, time of day, day of week, etc. Naturally, the user of the portable communication device 5-10 wants to know about the costs before incurred and wants to be able to control the costs while using the portable communication device.

An example of such a situation is shown in FIG. 6 where the communication resource is a radio link 6-14 between a mobile phone 6-10 and a base station 6-12. The base station is connected on a line 6-16 to a radio network controller (RNC) 6-18.

FIG. 7 shows a typical radio network controller connected by a line 7-20 to a core network 7-22 of a mobile communication system. The core network is in turn connected to other RNCs to allow other mobile phones to communicate with the mobile phone 6-10 of FIG. 6. It is also connected by a line 7-24 to other networks 7-26 including other kinds of networks to allow the mobile phone 6-10 to communicate with devices other than mobile communication devices or mobile phones in other kinds of mobile communication networks. These other networks may ultimately be connected as shown by a line 7-28 to yet another device 7-12 with which the mobile phone of FIG. 6 wishes to communicate.

It should be understood that the communication resource 5-14 of FIG. 5 can have costs associated with the use thereof attributable to different networks communicating information between the portable communication device 5-10 and the another device 5-12 or, it could simply mean the radio link 6-14 of FIG. 6. If the cost of use of the communication resource 5-14 of FIG. 5 involves more than one cost component, such cost components can be found out in advance for use by the user, according to the present invention of the portable communication device 5-10. Moreover, the ongoing cost of the communication can also be found out during the course thereof for purposes of communicating the cost on an ongoing basis to the user of the portable communication device 5-10. For instance, the operator of the core network 7-22 and RNC 7-18 of FIG. 7 can calculate the cost for the use of the radio link 6-14 while the other networks 7-26 can inform or be queried as to the cost for their use. Or, the cost for the use of these other networks can be known in advance and the core network or RNC of FIG. 7 can consult a look-up table where such already known costs can be retrieved for purposes of said invention.

Assuming the operator of the core network, for example, has ascertained the cost of the use of the total communication resource 5-14 (including other network costs) in advance or during the course of the communication, regardless of how it is expressed, the portable communication device 5-10 of FIG. 5 (in whatever form it takes such as the mobile phone 6-10 of FIG. 6) will receive a cost information signal indicative of the cost and will display or otherwise communicate to the user the cost indicator. It should be understood that although the above description suggests that the portable communication device receives the cost information signal from the core network, the RNC or the base station or somehow from some operator, it is not necessary for the information to be conveyed in that way. It could be prestored in the portable communication device. In that way, the portable communication device receives the cost information signal indicative of the cost for use of the communication resource by consulting a look-up table stored within the portable communication device itself or available locally through some resource other than the network via which the portable communication device communicates with the another device 5-12. The cost information could be downloaded to the user's PC and transferred to the user's portable communication device. Similarly, if a user owns or manages several different portable communication devices, the cost information could be transferred between the separate devices via suitable technical means other than a cellular network (with the associated cost), means such as Bluetooth, an infrared connection, a PC connection or a direct connection via a cable. (Thus, the cost information would be available during use of each of the different portable communication devices having been paid for only once.) Regardless of how the cost information is received by the portable communication device, the point of the present invention is to display or otherwise communicate to the user of the portable communication device a cost indicator based on the cost information signal and indicative of the cost for use of the communication resource 5-14.

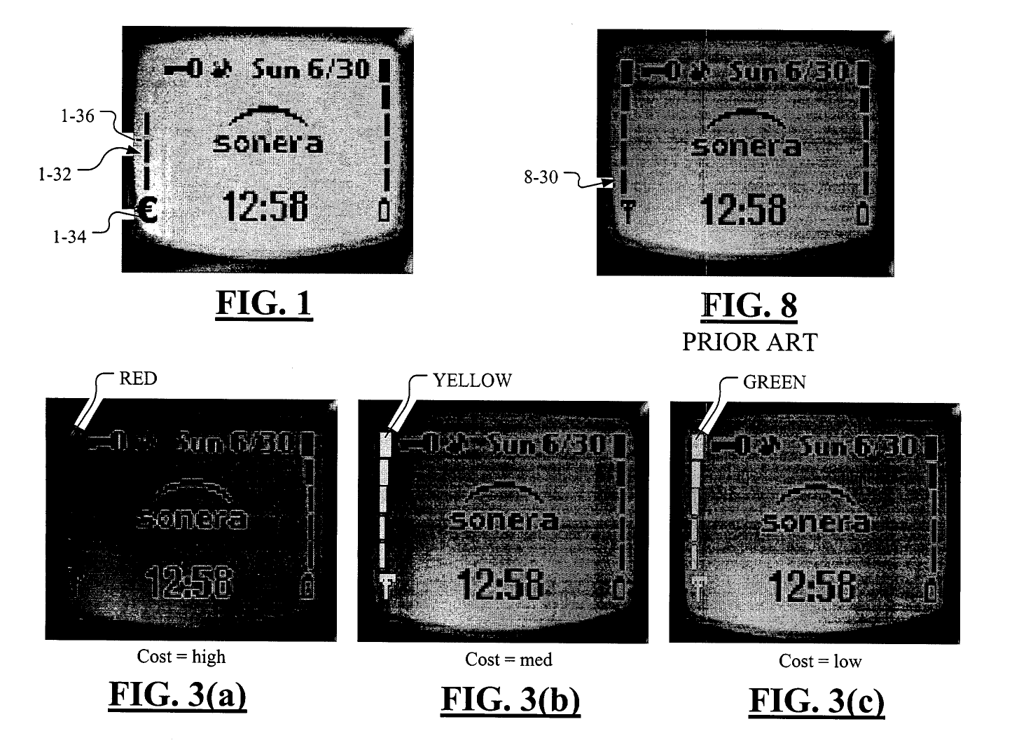

An example of displaying or otherwise communicating the cost indicator would be displaying the cost indicator on a display of the portable communication device for visual perception by the user. It is known, for instance, as shown in FIG. 8 to use a field strength indicator on the display of a mobile phone to show the signal strength from the base station to the mobile phone. In the same area of the standard field strength indicator, as shown in FIG. 1, the present invention shows a call cost indicator bar 1-32 which communicates the cost as a cost indicator, for visual perception by a user of the portable communication device, in this case, a mobile phone. The bar 1-32 comprises one or more line segments stacked vertically to indicate a greater amount of cost with more segments. An optional currency mark 1-34 may be used as shown (a Euro (ε) symbol), a dollar ($) symbol, a yen (¥) symbol, a pound (£) symbol, or the like. Additionally, a price level mark (1-36) may be shown to signify some price level such as 20 cents, 50 cents or $1.00 (if the call cost indicator bar is using a dollar as the optional currency mark). The price level mark can be left unlabeled (as understood) or can be explicitly labelled. Of course other kinds of quantitative indications could be used and the illustrated price level mark 1-36 is but an example. Without the price level mark, the call cost indicator bar comprises a qualitative indicator of the cost whereas it becomes a quantitative indicator when the price level mark is utilized. Whether quantitative or qualitative indicators are used depends on the nature of the information being communicated (such as by display) by the cost indicator, and also depends on the granularity (precision) of the information.

A common cost element (e.g. price per minute, price per transferred kB, currency) may be adopted by an operator or agreed upon between operators generally. Cost information for each call type—such as voice, data, SMS (Short Message Service), and GPRS—may be updated via the network; possibly also the currency may be set automatically via the network if needed. An indication of cost is shown in FIG. 1 as part of a user interface by illustrative call cost indicator bars 1-32.

Thus, just like the RF-field strength bar 8-30 provided in current mobile phones, as shown in FIG. 8, a call specific cost bar may provided as shown in FIG. 1 to indicate a given nominal cost level, e.g. price for a minute of voice call. This simple bar 1-32 creates an easily understandable user interface (UI) to help the user in understanding current cost level. As already explained above, the price level mark 1-36 may be used as shown to be indicative of a unit e.g. of 20 c, 50 c or 1 Euro or Dollar. The currency mark 1-34 may be used in place of the antenna icon of FIG. 11 when displaying the price bars. The field strength indicator may be displayed when appropriate and the call cost indicator bars may be displayed in the same area at times when a call is about to be initiated, during a call, or both. Likewise, they can be displayed alternately when a call is being initiated, during a call, or both.

The idea can be expanded for voice/data calls and Bluetooth connections. For example, three bars could be shown for these call-types. The cost bars can be updated via the network and the end-user can always see the current price level in real time for the available network connections. This will be informative if e.g. 900/1800 MHz operating ranges are changing due to movement during a day or according to the time of day.

Cost information is maintained in real time via the network as a terminal is moving among cellular systems. The cost information changes in many situations, such as: user moves from downtown (1800 MHz) to countryside (900 MHz), indicating changes due to RF band based pricing; high price during working day, lower at evenings, indicating changes due to time-of-day pricing; pricing according to network loading status, i.e. network optimization based pricing; special occasions (offers, campaigns, . . . ), indicating changes due to marketing based pricing; changes due to changes in communication parameters set by the user, indicating changes due to user-tailored pricing; changes due to travelling between countries using a different currency and, for example, having to keep costs in terms of a preferred currency subject to varying exchange rates, indicating changes due to preferred currency pricing. In addition, with respect to indicating changes in pricing, an informative “beep” sound or other indication at the moment of a pricing level change can be provided (with an on/off option), and cost indicator/field strength bars can be displayed exclusively or sequentially (one at a time) to save display area, with the network protocol implemented e.g. similarly to the present time/date updating feature.

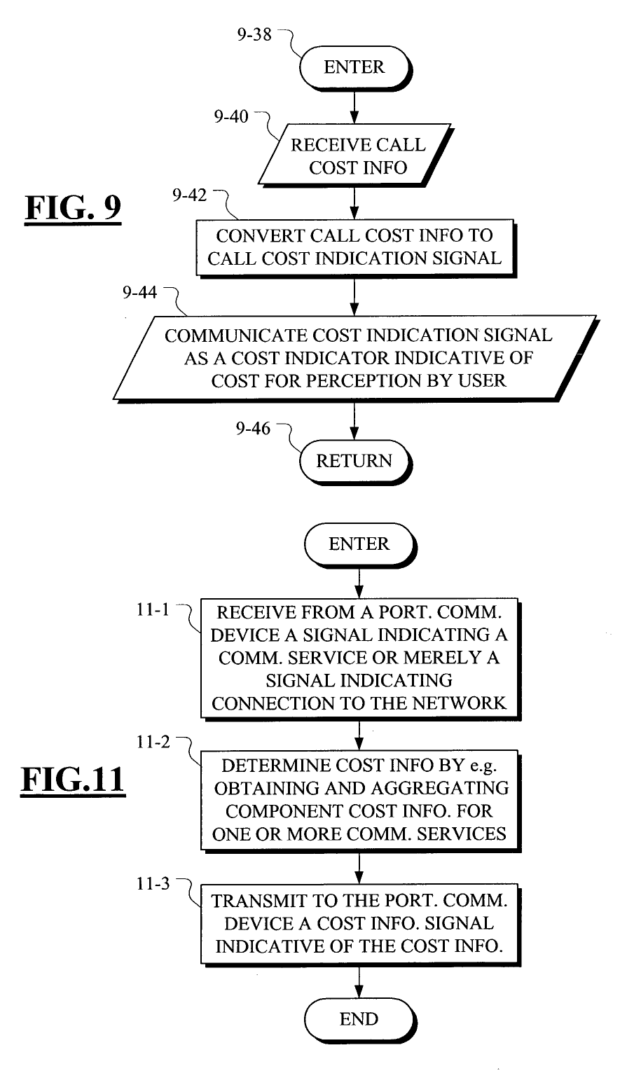

FIG. 9 shows the basic methodology of the present invention wherein after entering in a step 9-38, a routine of several steps is carried out by a signal processor within the portable communication device. In a first step 9-40, call cost information is received either by external communication with the network or by retrieving prestored information. Prestored information may also have been obtained from the network, and is preferably cost information not for a specific communication service, but rather information that can be used by the portable communication device to determine the cost for any of various communication services. In a next step 9-42, a call cost indicator is determined based on the received or retrieved call cost information. The received or retrieved call cost information can be either the actual cost of the communication service being used or contemplated, or, more typically elements or components of the cost of the communication service from which the portable communication device determines the cost and a corresponding cost indicator. If the received call cost information signal as received in step 9-40 is the cost itself (as opposed to being information from which the cost can be determined such as component costs that must be added to arrive at the cost, or time periods having different billing rates and the billing rates for the different time periods) and is already in a suitable format, the step 9-42 can be skipped and a step 9-44 executed directly in which the call cost indicator is displayed or otherwise communicated for perception by the user of the portable communication device. A return is then made in a step 9-46. The entry step 9-38 can be entered from any other related procedure such as a procedure to consult a look-up table or a procedure to consult the network for call cost information. Similarly, the return step 9-46 will return the routine of FIG. 9 to the originating program. The essential steps as shown in FIG. 9 will be the same, regardless of the methodology used to receive the call cost information.

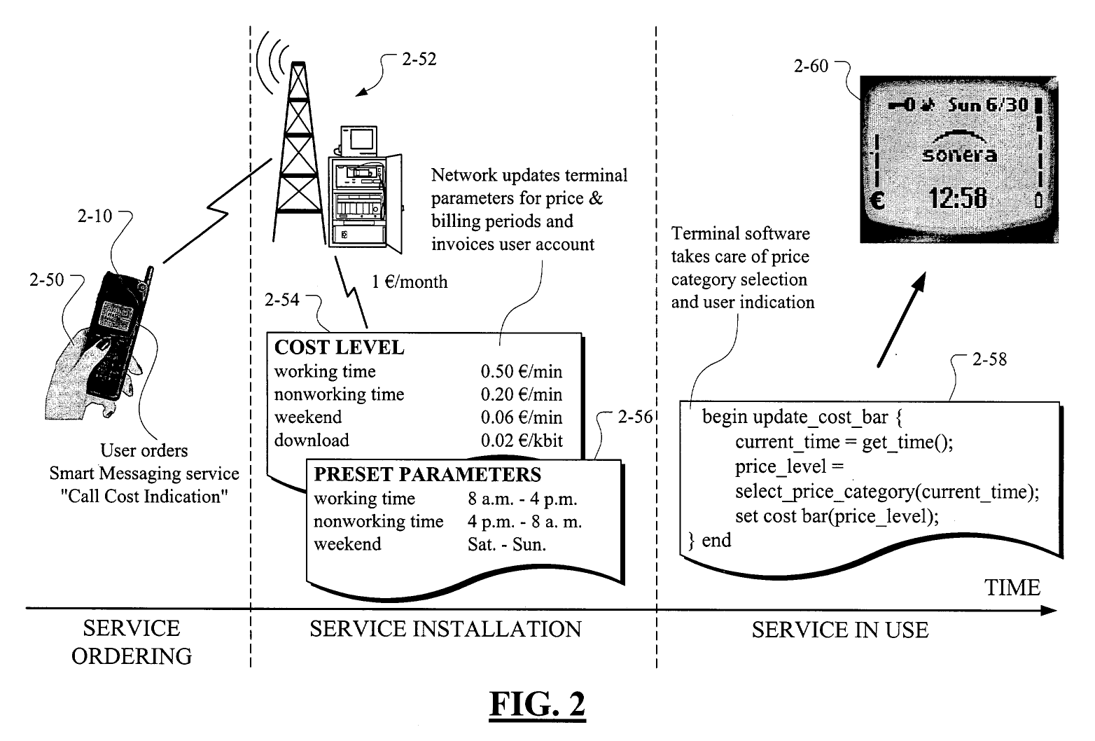

As shown in FIG. 2, for example, the cost information can be obtained at the time of ordering the call-cost-indicating service from the network. A user 2-50 is shown ordering a smart messaging “call cost indication” service by means of a portable communication device 2-10 from a service installation 2-52 which may be a base station and RNC such as shown in FIG. 6. The service installation consults cost levels 2-54 and preset parameters 2-56 and updates terminal parameters for pricing and billing periods and invoices the user account. This smart messaging service might cost the user 1 Euro per month for example. After the device 2-10 receives a cost information signal indicative of the call cost, the device's software 2-58 then takes care of price category selection and user indication as shown during a service in use period. A display 2-60 of the device 2-10 shows the cost indicator bar of FIG. 1 indicating the price level as compared to a price level mark and the user is able to recognize the currency symbol as well. As explained above, the price level mark will be understood or even displayed with appropriate numerals, if desired. It is worth noting that product usability can be especially improved in a fast network—i.e. one providing fast connection and fast response, such as GPRS (General Packet Radio Service) protocol or very fast 3G cellular systems—by providing the cost indication at the moment when a call is actually made. At the point in time when a call is initiated, the call type (voice, data, download, or internet connection, and so on) and call destination is known, and so before completing the call, the device could first send a cost inquiry to the network and then immediately show the cost indication and prompt for user agreement to engage the service at the indicated cost. The user can signal agreement by e.g. a second press of a typical call-button (green dial button, send-button) or decline to agree by pressing a call termination button (end button). Use of this kind of confirmation dialog could be activated or deactivated via a call-settings menu of the cell phone user interface, according to user preference, like other parameters in current cell phones.

The methodology shown in FIG. 2 is one way to solve the problem of how the phone terminal can have the price information before dialing since the destination is unknown. The pricing can be done in different ways as suggested in FIG. 2 for example by cost level, preset parameters or the like. Various alternatives might include: price by time of day, price by transferred kbit, price per service, price by network loading status, and price by network loading status, as described next.

Price by Time of Day

Assuming that billing periods and prices are known in advance, there are two options. In a first option, the network can use time based pricing zones (high/low, high/medium/low, such as working time, evening time and weekend) and send the cost information to terminals via a SMS service in which case the terminals take care of daily indication of actual price level with their clocks. In a second option, the cost information is automatically sent daily to terminals by SMS messages with preset code, similar to a ring tone download today.

SMS messaging can be substituted with other more efficient messaging methods, such as GPRS or MMS or Smart Messaging, when available. It is possible that the Smart Messaging might be the most preferred method for pricing information exchange, as it would be a service similar to downloading ringing tones (paid and ordered by customer), that could be used to update cost-parameters in the terminal, that are used to store the cost level information and where it can be displayed from.

Price by Transferred Kbit

A network can set kbit/s-based pricing zones in the same way as time-based pricing, explained above. A disadvantage is that a user typically does not know in advance the size of the data file the user would like to download. For example, an image file size is difficult to evaluate beforehand; it can be in many image formats and resolutions. On the other hand, the prospective sending device typically does know the file size, and so the cost can be estimated based on size information provided to the network by the prospective sending device.

Price Per Service

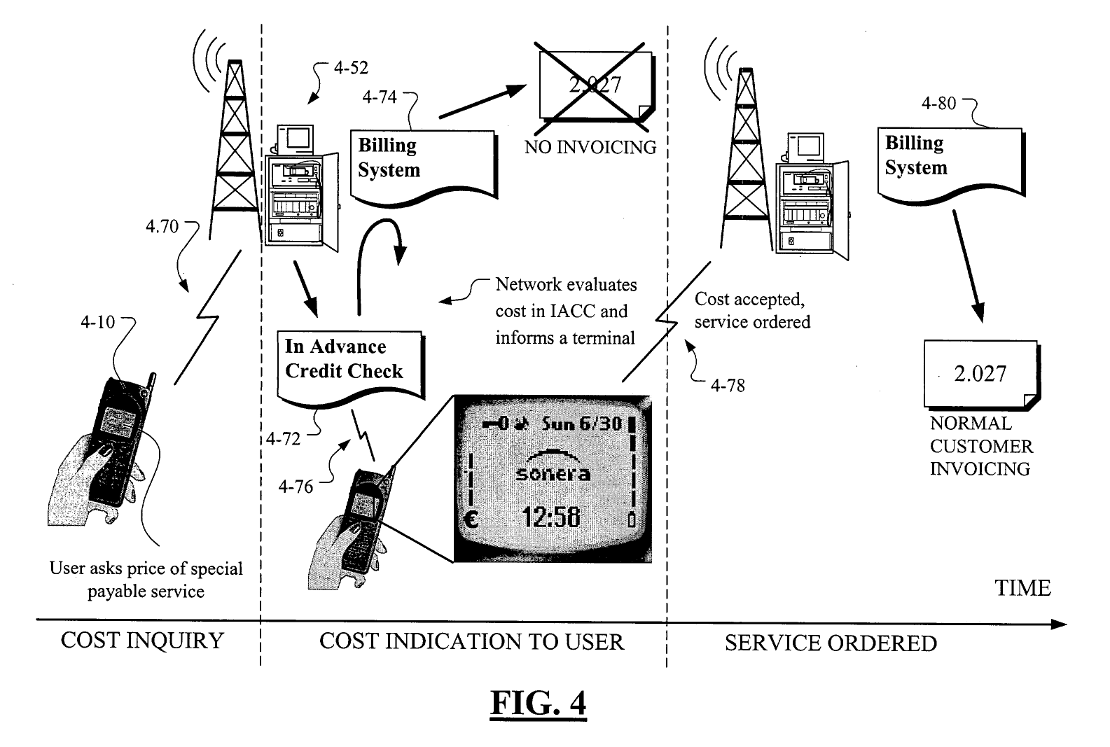

Typically, a network service is priced by access/call; however, a user could ask for the service cost before ordering it. This means that the cost bar would not show the price level all the time but only after inquiry for this kind of service. This can be done by means of a feature called In Advance Credit Check (IACC) service. In a proprietary Charging Center (network module), presently under development by the assignee hereof, the IACC is capable of asking a network billing system to provide or explain the service cost without invoicing the customer account. In FIG. 4, a user of a portable communication device 4-10 asks through a user interface for the price of a special payable service. This request is transmitted 4-70 to the network 4-52 where an in advance credit check 4-72 is performed. Note that the billing system 4-74 does not generate any invoice. The network evaluates the cost in the IACC and informs the terminal by communicating the cost to the terminal as shown by the cost indicator bar in FIG. 4. The user then has an opportunity to accept or decline the service based on his or her evaluation of the cost. As indicated by a communication 4-78, the cost may be accepted and the service ordered through the network. The billing system 4-80 then generates normal customer invoicing, as shown.

Price by Network Loading Status

Network loading can be used as a source for special offers during the course of a day and especially during high traffic periods. Making such special offers requires on-time messaging via e.g. the SMS (Short Message Service) service. Using special offers tied to network loading, network operators can optimize network loading by setting price levels by each RF cell/base station (i.e. performing direct network loading geographically) and/or by guiding calls into evening time when the network load in a cell is high. Special offers to affect network loading are beneficial in areas where changes in network loading occur quickly, such as in areas where traffic can sometimes be high, such as areas including highways and railroads. The network could inform a phone of the special offers/changes in price by updating the cost parameters in the phone, and the phone could alert the user. For example, a cell phone user travelling away from a large city in a car or train might be given an indication by the phone that the cost level is especially high by that by waiting for a short time for the car or train to move to another (base station coverage/cell) area, the price level is likely to be less.

The cost bar of FIG. 1 is one example of possible ways to show cost, other possibilities exists also:

numerical display: price level shown with numbers at adequate location of the display;

analog circular gauge: similar to speed indicator in car;

colour code: coloured text/icon/mark/graphics, e.g. red to indicate high cost (FIG. 3(a)), yellow to indicate medium cost (FIG. 3(b)), and green to indicate low cost (FIG. 3(c));

absolute display: actual price level shown in currency;

relative display: shows only low/medium/high levels without accurate value of pricing, independent of currency, i.e. display is same globally (the reference value could be tied to a suitable financial index, preferably a global financial index, or e.g. to an estimate of the mean cellular network usage cost among all network operators);

graphical indication: any visual indication other than above, e.g. icon, animation, pictures, colour changes in display (or item on display);

audible indication: sounds or other audible clues to indicate change in cost level, could be user defined sound file etc.;

haptic indication: use of vibra alert for cost level change indications, given haptic feedback, also known as tactile feedback, i.e. e.g. mechanical vibration;

indication by illumination: device illumination can be used to indicate cost level, standby keypad/display illumination, flashes, other illuminated decorative elements, and so on;

combination of above: the RF field strength bar could for example change its colour according to cost level, e.g. red RF bar indicating high cost (FIG. 3(a)), yellow RF bar (FIG. 3(b)) indicating medium cost, and green RF bar (FIG. 3(c)) indicating low cost, and using such coloured RF field strength bars as a qualitative call cost indicator has as a benefit requiring minimal changes to current UI (user interface) style and graphics, and the interpretation of such coloured RF bars as indicating network access cost is intuitive.

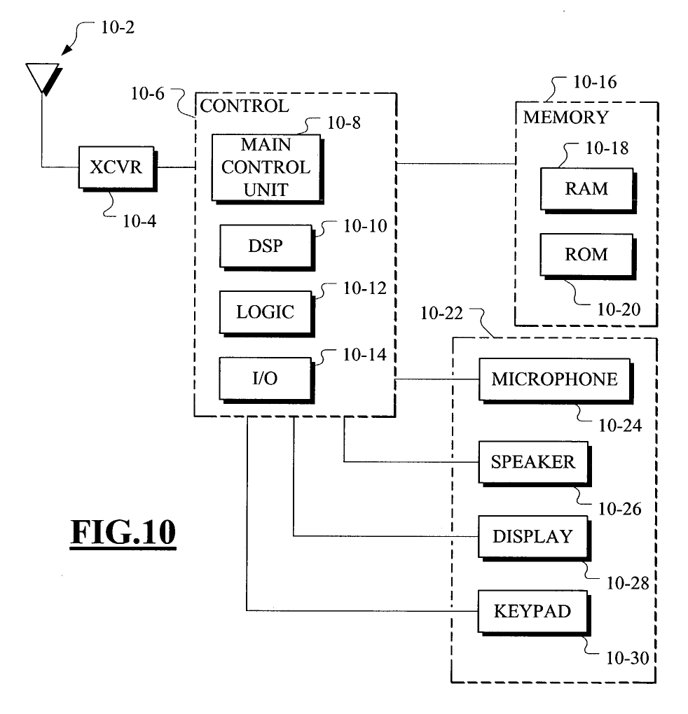

FIG. 10 illustrates a portable communication device capable of communicating with another device using a communication resource at a cost, according to the present invention. The device of FIG. 10 comprises a mobile telephone but is not limited thereto. It includes an antenna 10-2 for transmitting and receiving over a radio link such as the radio link 6-14 shown in FIG. 6. The antenna is connected to a transceiver 10-4 which may include various components such as filters, a modulator, a demodulator, amplifiers, scramblers, descramblers, etc., which are not pertinent to the present invention. The transceiver 10-4 is connected to a control 10-6 which may include one or more integrated circuits having the function of a main control unit 10-8, a digital signal processor 10⁻¹⁰, logic 10-12, and input/output interface 10-14, and various other components known to one of skill in the art. The control is connected to a memory 10-16 which may include a random access memory (RAM) 10-18 and a read only memory (ROM) 10-20, including any variants of these memories implemented in a removable memory card, or other removable memory media. These memory components can take various forms but generally the ROM 10-20 will be used to store programs and other unchanging code while the RAM 10-18 may be used for temporarily storing information that changes. A user interface 10-22 is also connected to the control 10-6 and may include a microphone 10-24, a speaker 10-26, a display 10-28, and a keypad 10-30. The series and steps shown in FIG. 9 may be written in computer code and stored in the ROM 10-20 of FIG. 10 and retrieved by the control 10-6 when execution thereof is called for. The main control unit 10-8 may execute the retrieved code in order to perform the steps shown in FIG. 9 in retrieving code and cost information for instance from the RAM 10-18 or from the network over the radio link. The received call cost information, whether from the network or the memory, may then be converted by the main control unit from call cost information to a call cost indicator suitable for display by the display 10-28, the converting possibly involving adding component costs and using look up tables to determine the billing rate that applies at the time of use of the communication service being engaged. Alternatively, as mentioned above, if the received call cost information signal directly indicates the cost to be indicated and is already in the desired format, no conversion is necessary and the control 10-6 will communicate to the user the cost indication signal as a cost indicator through for instance the user interface 10-22. Specifically, for the example given previously, the display 10-28 may be used by the control 10-6 to display a cost indicator indicative of cost for visual perception by the user of the device of FIG. 10. Consequently, it will be understood that the device of FIG. 10 includes means for carrying out the steps shown in FIG. 9 in functional blocks that roughly correspond to the steps 9-40, 9-42 and 9-44 which may be carried out most efficiently by computer code stored in the ROM 10-20 of the memory 10-16 of FIG. 10.

In addition: if the RF-field strength bar is visible normally, the cost-bar could be turned on by user activation (specific button, button sequence or combination, menu-selection, voice input, or other user input method); RF-field strength bar and cost-bar can exclusively alternate after preset intervals, e.g. 5 or 10 seconds; cost bar could appear (optionally with beep sound/vibra alert) when pricing basis is changed, e.g. when more expensive day-time pricing changes to low cost evening time; end user can select if the RF/cost bar is his/her primary indicator, while the other stays on background and is visible only when requested by any means mentioned above; RF-field strength bar appears only when RF-field is getting low, which is the only moment when it has any practical meaning; otherwise the cost bar stays visible; any combination of above can be used; and application itself can be implemented in terminals either as 1) proprietary integrated software or as 2) Java SW, Java based implementation is easier to install to large number of devices.

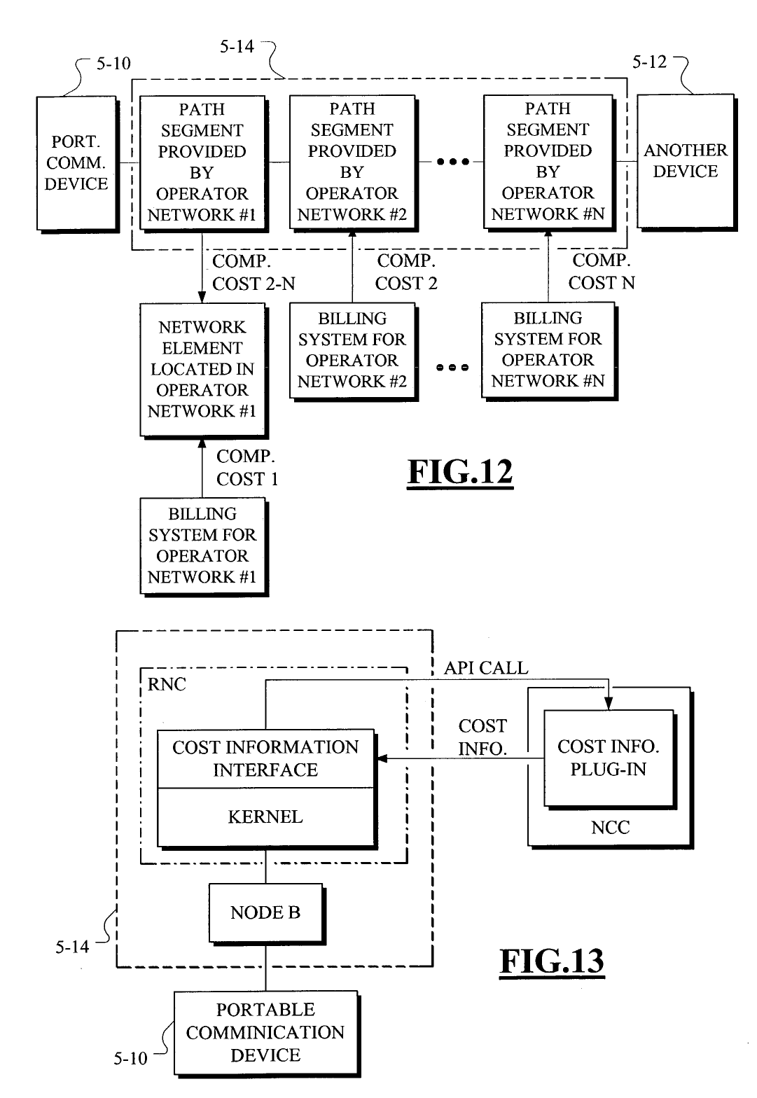

Referring now to FIGS. 11 and 12, FIG. 11 is a flow chart indicating the operation of a network element cooperating with a portable communication device operative according to the invention, as indicated for example in FIG. 9, in the case that the portable communication device is not preloaded at the factory with cost information that can be used by the portable communication device to provide cost indicators for any of a number of communication services, i.e. with general cost information, not limited to a particular communication service. (In case of such preloading, the cost information would be updated by the network element to stay current with cost information changes.) As shown in FIG. 11, in a step 11-1 the network element receives a signal from a portable communication element, a signal that may indicate a particular communication service or may simply connect the portable communication device to the network. In case of indicating a particular communication service, the cost information to be provided is specific to the indicated communication service, but otherwise is general cost information, not limited to an indicated communication service. In a next step 11-2, the network element determines cost information by for example obtaining and aggregating component cost information for one or more communication services. The component cost information may be for example costs for each of several different media in a multimedia communication, or costs for use of different communication path segments needed in providing the one or more communication services, in which case the network element typically communicates with other operator networks providing the different communication path segments to obtain the respective component costs, as illustrated in FIG. 12. In a next step 11-3, the network element transmits to the portable communication device a cost information signal indicative of the cost information. As mentioned above, the cost indicator displayed or otherwise communicated to the user by the portable communication device can indicate the cost for a communication service either quantitatively (as a numerical billing rate) or qualitatively (e.g. low, moderate or high cost). In case of the latter, either the cost information can be transmitted to the portable communication device as quantitative cost information with a corresponding qualitative cost indicator then being determined by the portable communication device, or the cost information can be transmitted to the portable communication device as (only) qualitative information.

As would be appreciated by one skilled in the art, each of the steps indicated in FIG. 11 can be carried out by corresponding modules of software stored on a ROM (read only memory) device or other non-volatile memory device and loaded into the RAM (random access memory) of a CPU (central processing unit) of e.g. a microprocessor. Thus, e.g. corresponding to the step 11-1 of FIG. 11, there is a corresponding module. The modules may be discrete, able to be executed by the CPU independently, or may be linked together into one single combined module or into several different combined modules.

The invention also encompasses not only providing a cost indicator for a communication service a user of a portable communication service is using, but also for providing a cost indicator for a communication service such a user is contemplating using. In case of the latter, upon viewing or otherwise perceiving the cost indicator for a contemplated communication service, the user might choose to decline to engage the communication service. Thus, the cost information provided by the network element is at least in some embodiments independent of whether an invoice is generated for the user in connection with use of a communication service. In a typical embodiment, however, regardless of whether the cost information is tied to an invoice, the network element obtains the cost information from the billing system for the operator network to which the portable communication device is subscribed. In some embodiments, when more than a single operator network is involved in providing a communication service, (as generally indicated in FIG. 12) the network element obtains the cost information from a plurality of billing systems, each an element of a different operator network that participates in providing the communication service.

Referring now to FIG. 13, the network element 5-14 transmitting the cost information signal is typically a Radio Network Controller (RNC) in combination with a node B/base station, and the network element obtains the cost information from a Network Control Center (NCC) via Application Programming Interface (API) calls to the NCC (the calls being made to a cost information plug-in located in the NCC by a kernel via a cost information interface both located in the RNC). Alternatively, the network element can be for example a Multimedia Service Center (MMSC) or a Short Message Center Service center (SMSC), again obtaining the cost information from a NCC via API calls to the NCC, and operating in combination with an RNC and a node B/base station. In addition to providing cost information, a credit check can be performed in combination with providing the cost information, with the user allowed to order the communication service only if the credit check indicates a favorable user credit report.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. A method, for use in a portable communication device capable of communicating with another device using a communication resource at a cost, comprising the steps of:
receiving a cost information signal indicative of said cost; and
communicating a cost indicator for perception by a user of said portable communication device, the cost indicator based on the cost information signal and indicative of said cost.

2. The method of claim 1, wherein said step of communicating comprises the step of displaying said cost indicator on a display of said portable communication device for said perception by said user of said portable communication device.

3. The method of claim 2, wherein said displaying said cost indicator is carried out by displaying different colors of displayed pixels or pixel structures signifying different cost levels with one color displayed at a time to signify a corresponding cost level.

4. The method of claim 2, wherein said displaying said cost indicator is carried out by displaying a graphical icon that changes size in steps with a larger size signifying a higher cost.

5. The method of claim 2, wherein said displaying said cost indicator is carried out by displaying a graphical icon that shows said cost with respect to a selected currency.

6. The method of claim 5, wherein said icon shows said cost with respect to one or more price level marks indicative of one or more corresponding price levels in said selected currency.

7. The method of claim 2, wherein said step of displaying said cost indicator is carried out by displaying a graphical icon indicative of a price level per unit time.

8. The method of claim 2, wherein said cost indicator alternates on said display with a field strength indicator.

9. A method as in claim 1, wherein in place of communicating a cost indicator for perception by a user of said portable communication device, the method includes the steps of:
transferring the cost information signal from said portable communication device to another portable communication device via connectivity provided by other than the telecommunication network; and
communicating a cost indicator for perception by a user of said other portable communication device, the cost indicator based on the cost information signal and indicative of said cost.

10. A method, for use by a network element of a telecommunication network enabling a portable communication device to engage a communication service at a cost so as to communicate with another device, the method comprising the steps of:
receiving a signal from the portable communication device indicating to the network element the identity of the portable communication device; and
transmitting to the portable communication device a signal conveying cost information indicative of the cost for engaging a communication service.

11. The method of claim 10, wherein the signal from the portable communication device indicates the communication service and the cost information is limited to the indicated communication service.

12. The method of claim 10, wherein the cost information is not limited to a particular communication service.

13. The method as in claim 10, wherein the cost information is information indicative of a total charging rate for the communication service.

14. The method as in claim 10, wherein the cost information is a current total cost accrued during a communication session using the communication service.

15. The method as in claim 10, wherein the cost information indicates different billing rates for use of the communication service during different time periods.

16. The method as in claim 10, wherein, before the step of transmitting the cost information, the network element performs the step of aggregating component cost information indicative of component costs for engaging the communication service.

17. A method as in claim 16, wherein in aggregating component cost information, the network element arithmetically adds together the component costs.

18. A method as in claim 16, wherein in aggregating component cost information, the network element assembles different component cost information into a single cost information document or table.

19. A method as in claim 16, wherein the communication service is provided over a communication path including path segments provided by different operator networks, and in aggregating component cost information, the network element receives component cost information from a network element in at least one operator network different from the operator network to which the aggregating network element belongs.

20. A method as in claim 16, wherein each component cost is a cost for a respective one of a plurality of media.

21. A method as in claim 16, wherein each component cost is a cost for a respective one of a plurality of path segments over which the communication service is conveyed.

22. A method as in claim 10, wherein the cost information is transmitted before receiving the signal indicating the communication service.

23. A method as in claim 10, wherein the cost information is transmitted after receiving the signal indicating the communication service.

24. A claim as in 23, wherein the signal indicating the communication service is a signal making use of the indicated communication service.

25. A method as in claim 23 wherein the signal indicating the communication service is a signal indicating a communication service a user of the portable communication device is not using but for which the user requests cost information.

26. A method as in claim 25, wherein the network element obtains the cost information independent of whether an invoice is generated for the user in connection with use of the communication service.

27. A method as in claim 25, wherein the user makes use of the communication service after receiving the cost information.

28. A method as in claim 25, wherein the network element obtains the cost information from at least one billing system.

29. A method as in claim 25, wherein the network element obtains the cost information from a plurality of billing systems, each an element of an operator network that participates in providing the communication service.

30. A method as in claim 25, wherein the network element obtains the cost information from a Network Control Center (NCC) via Application Programming Interface (API) calls to the NCC.

31. A method as in claim 30, wherein the network element is a Multimedia Service Center (MMSC).

32. A network element as in claim 30, wherein the network element is a Short Message Center Service center (SMSC).

33. A method as in claim 25, wherein a credit check is performed in combination with providing the cost information, and the user is allowed to order the communication service only if the credit check indicates a favorable user credit report.

34. A portable communication device capable of communicating with another device using a communication resource at a cost, comprising means so as to be operative according to claim 1.

35. A network element, comprising means so as to be operative according to claim 10.

36. A system, comprising at least one portable communication device as in claim 34 and at least one network element.

37. A system, comprising at least one portable communication device and at least one network element as in claim 35.
